(19) United States
(12) Patent Application Publication
(10) Pub. No.: US 2009/0187512 A1
(43) Pub. Date: Jul. 23, 2009

(54) Asset-backed investment instrument and related methods

(75) Inventors: Jeffrey A. Giroux, Summit, NJ (US); Philip Prince, New York, NY (US); Patrick McCarthy, Winnetka, IL (US); Janet Wiener, New York, NY (US); John Cho, New Rochelle, NY (US); Mark Sun, Scarsdale, NY (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: JP Morgan Chase Bank, New York, NY (US)

(21) Appl. No.: 11/141,551

(22) Filed: May 31, 2005

(51) Int. Cl. G06Q 40/00

(52) U.S. Cl. 705/36 T

(57) ABSTRACT

An asset-backed investment instrument that increases deferred tax liabilities for an investor and, therefore, is attractive to any investor that benefits from deferred tax liabilities, such as certain insurance companies. Ownership of an asset underlying the investment instrument is transferred to an investing entity. The transferred asset is leased from the investing entity for a predetermined period. The lease may include a like-kind exchange feature to lengthen the predetermined period of the lease and to allow the accrued deferred tax liabilities to remain outstanding for a longer period of time. The lease may also include a Terminal Rental Adjustment Clause to remove the risk of a change in an estimated residual value from the investing entity.

### FIELD OF THE INVENTION

This invention relates to providing an asset-backed investment. In particular, this invention pertains to providing an asset-backed investment that is attractive to a new class of investors, specifically, insurance companies. The asset-backed investment includes a transfer of asset ownership rights and, optionally, a like-kind exchange feature, and/or a Terminal Rental Adjustment Clause (“TRAC provision”).

### BACKGROUND OF THE INVENTION

As reflected by its name, an asset-backed security (“ABS”) is a security, such as a bond or a note, that is backed by a pool of assets, such as automobile loans, automobile leases, railcar leases, airplane leases, credit card receivables, or student loans. A conventional ABS having automobile and light-duty truck leases (collectively, “vehicle leases”) as the underlying assets is illustrated with reference to FIG. 1. An automobile finance company (“AFC”) 101 is in the business of financing vehicle leases. The AFC 101 may be represented by an issuer financial advisor and/or arranger 108 (“IFAA”). IFAA 108 may advise the AFC 101, or any of its related entities, on the structure of the ABS, the marketing of the ABS to investors, the preparation of the offering memorandum, known in the art, discussions with accounting personnel, discussions with tax and/or legal counsel, the investor bid process, documentation, and the closing of the transaction. The AFC 101 typically owns a titling trust 102 that retains title to the leased vehicles. To facilitate the transfer of ownership of the vehicles, without having to undergo the cost of retitling them, the AFC 101 typically identifies and designates a specific portfolio of leased vehicles in the trust and instructs the trust to issue a certificate representing the ownership of such portfolio including all cash flows assumed with such vehicles, such certificates sometimes referred to as special units of beneficial interest (“SUBI”) or specific interest certificates (“SIC”) or another similar name depending on the respective AFC 101. Therefore, when used, only the SUBI, SIC, etc., needs to be transferred in order to transfer ownership of the leased vehicles owned by the trust 102. The AFC 101 is referred to as a “Servicer” because the AFC 101 usually is responsible for servicing and maintaining the leased vehicles from the proceeds of the ABS.

To initiate a vehicle lease ABS, the AFC 101 typically instructs the titling trust 102 to create a SUBI for a pool of leased vehicles which now makes up the assets of the ABS. Alternatively, the AFC 101 can directly create a SUBI. The AFC 101 also typically forms a special purpose entity (“SPE”) 103 to which the AFC 101 sells, transfers, and assigns the SUBI. The SPE 103 then typically transfers the SUBI to a newly formed statutory trust (“issuer”) 104 in return for Class A certificates. The Class A certificates represent an equity interest in the issuer 104 and provide credit enhancement for other investors in the issuer 104. The Class A certificates are transferred to Class A certificate holders 106. The issuer 104 is the issuer of the ABS, because it issues notes to term ABS investors 105 in return for cash. Cash flows received by the issuer 104 from the SUBI, i.e., lease payments from the underlying users and residual proceeds from the purchase or disposition of the underlying vehicles, are used to service the obligations of the issuer 104 under the notes. The issuer 104 also pledges its assets to an Indenture Trustee 107 as security for the notes.

An illustrative example of an investor's 105 reporting for a $100 million investment, according to the conventional ABS lease structure of FIG. 1, will be described with reference to FIG. 2. The GAAP Income column 201 represents income recorded as per the Generally Accepted Accounting Principles, known in the art, and the Taxable Income column 202 represents income recorded for tax purposes. GAAP, as referred to herein, is intended to include statutory accounting principles, as are known to those skilled in the art, for companies that are regulated, such as insurance companies. The GAAP Income column 201 and the Taxable Income column 202 are the same in a conventional asset-backed security structure, because the investors 105 are considered debt investors for both GAAP and tax reporting purposes. The GAAP Taxes Recorded column 203 shows the GAAP Income column 201 multiplied by a tax rate of 36.95% (assuming a 35% federal tax rate and a 3% state tax rate). The Taxes Paid (Deductions Received) column 204 shows the Taxable Income column 202 multiplied by a tax rate of 36.95%. The Deferred Tax Liability column 205 shows the GAAP Taxes Recorded column 203 minus the Taxes Paid column 204, and represents the deferred tax liability (“DTL”) accumulated for the investor(s) in each corresponding year. The Cumulative DTL column 206 represents the cumulative DTL for the corresponding year and each previous year.

As illustrated in FIG. 2, the conventional ABS depicted in FIG. 1 does not create any deferred tax-liability benefits to the investors 105. Further, the duration or term of the conventional ABS is limited by the length of a conventional automobile lease, which may range from 24-60 months, with a typical average ABS life of two to four years. A need in the art exists for an improved ABS that provides more benefits to investors.

### SUMMARY OF THE INVENTION

The above-described issues are addressed and a technical solution is achieved in the art by an asset-backed investment instrument that, among other things, increases deferred tax liabilities for an investor, and is rated by a Nationally Recognized Statistical Rating Organization (“NRSRO”), and therefore, is attractive to any investor that benefits from deferred tax liabilities and needs rated investments, such as certain insurance companies. Deferred tax liabilities are generated, according to an embodiment of the present invention, due to varying tax payment schedules under GAAP, statutory, and tax reporting. An ABS that generates a deferred tax liability allows, for example, many insurance company investors to generate regulatory capital, known in the art, and allows a longer duration ABS to extend the life of that regulatory capital. A benefit of using rated investments is that such use can facilitate a company's compliance with state investment laws and regulatory capital requirements, as are known to those skilled in the art. A benefit of the present invention is that it attracts insurance company investors that otherwise would not invest in an ABS.

According to an embodiment of the present invention, deferred tax liabilities are increased for an investor by transferring the tax ownership of assets, in whole or in part, underlying an ABS to an investing entity. Ownership of other assets and/or a cash accumulation/reserve account may be retained and pledged as collateral to the investing entity. The investing entity may be an investor, an entity owned at least in part by an investor, or an entity having an ancestor that is owned at least in part by an investor. The investor may be an insurance company or any other investing entity that benefits from deferred tax liabilities. The transferred assets may be automobiles, motorcycles, airplanes, boats, ships, real property, or any other capital asset for which tax depreciation may be claimed. The transferred assets are leased from the investing entity for a predetermined period and may be subleased to consumers. The predetermined period may be based upon a useful life of the transferred assets. According to an embodiment of the present invention, the predetermined period may be up to 80% of the useful economic life of the transferred assets. If the assets are leased automobiles, the predetermined period may be 6 to 8 years, assuming an 8 to 10 year life of an automobile.

To extend the benefits of deferred tax liabilities, an embodiment of the present invention implements a like-kind exchange (“LKE”) feature. According to the LKE feature, when an asset underlying the ABS is sold, for instance, at the end of a lease, the proceeds from the sale are invested in another like-kind asset pursuant to the provisions of IRS Code Sections 1031 and 1033 and the regulations thereto, known in the art. With this feature, the sale of the asset is not a taxable event to the investing entity, taxes are deferred over the remainder of the predetermined period, and tax liability is further deferred.

According to an embodiment of the present invention, a Terminal Rental Adjustment Clause (“TRAC provision”) is provided to further enhance investment attractiveness to investors. The TRAC provision allows the investors to receive the tax benefits of owning the assets while minimizing the risk of a change to the residual value of the assets. The TRAC may specify that, at the end of the predetermined period, if an actual residual value realized from the sale or disposition of the transferred assets is less than an estimated residual value of the transferred assets at an inception of a lease, a payment (the “TRAC”) is made to the investing entity 105 in an amount corresponding to the difference between the estimated residual value and the actual residual value. Accordingly, if the actual residual value is greater than the estimated residual value at the end of the predetermined period, the SPE 103, or “transferor,” is entitled to such excess. Further, the TRAC provision allows the investors to record a larger residual value estimate since the residual value is effectively guaranteed and therefore requires less ongoing rental payments from the lessee, resulting in a greater deferred tax liability for the investors. According to an embodiment of the present invention, the TRAC provision is structured pursuant to IRS Code Section 7701(h), known in the art.

### BRIEF DESCRIPTION OF THE DRAWINGS

The present invention will be more readily understood from the detailed description of preferred embodiments presented below considered in conjunction with the attached drawings, of which:

FIG. 1 illustrates a conventional asset-backed security lease structure;

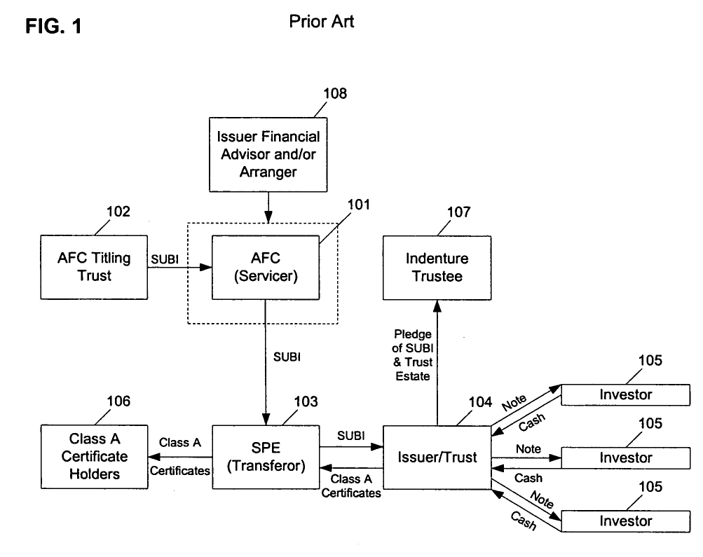

FIG. 2 illustrates the reporting for a $100 million investment, according to the conventional asset-backed security lease structure of FIG. 1;

FIG. 3 illustrates an asset-backed security lease structure, according to an embodiment of the present invention;

FIG. 4 illustrates a process for implementing an asset-backed lease, according to an embodiment of the present invention; and

FIG. 5 illustrates the reporting for a $100 million investment, according to an embodiment of the present invention.

### DETAILED DESCRIPTION OF THE INVENTION

The present invention provides various embodiments of an asset-backed security (“ABS”) to increase deferred tax liabilities for an investor and, therefore, is attractive to any investor that benefits from deferred tax liabilities, such as, certain insurance companies. However, one skilled in the art will appreciate that, any investor may make use of the present invention regardless of whether they benefit from deferred tax liabilities. A deferred tax liability (“DTL”) is a GAAP book account that represents an obligation to pay taxes at a future date. DTLs are generated due to varying tax payment schedules under GAAP and tax reporting. For example, a faster tax depreciation schedule as compared to a company's GAAP schedule can allow a company to defer the payment of taxes that are recognized under GAAP reporting. This would cause the company to have a DTL.

One type of investor that benefits from DTLs are certain insurance companies, because DTLs allow the insurance companies to generate additional statutory surplus, known in the art. Statutory surplus is an accounting measurement that state regulators and rating agencies use to evaluate the solvency of an insurance company. In other words, statutory surplus is a measure of the financial vitality of an insurance company. Accordingly, the higher an insurance company's statutory surplus is, the more attractive the insurance company is to investors.

To elaborate, statutory surplus represents the degree to which an insurer's assets considered liquid by regulators exceed the insurer's liquid liabilities. One form of assets considered liquid is known as admitted deferred tax assets, or admitted “DTAs.” A DTA is a GAAP book account that reflects the recognition for GAAP book purposes of future tax savings. However, not all DTAs contribute towards an insurance company's statutory surplus. Only those DTAs considered liquid by state regulators are admitted into the statutory surplus calculation and, thus, are termed “admitted DTAs.” Therefore, the more admitted DTAs an insurance company has, the higher its statutory surplus will be.

Admitted DTAs are calculated as the sum of: (1) federal income taxes paid in prior years that may be recovered through loss carrybacks for existing temporary differences that reverse by the end of the subsequent calendar year; (2) the lesser of a) the amount of DTAs expected to reverse in one year or b) 10% of statutory surplus; and (3) the amount offset by DTLs. Regarding element (3), the more DTLs an insurance company has, the more admitted DTAs it has, and the more statutory surplus it has. Therefore, certain insurance companies who invest in the asset-backed investment, according to the various embodiments of the present invention, increase their DTLs and, consequently, their statutory surplus.

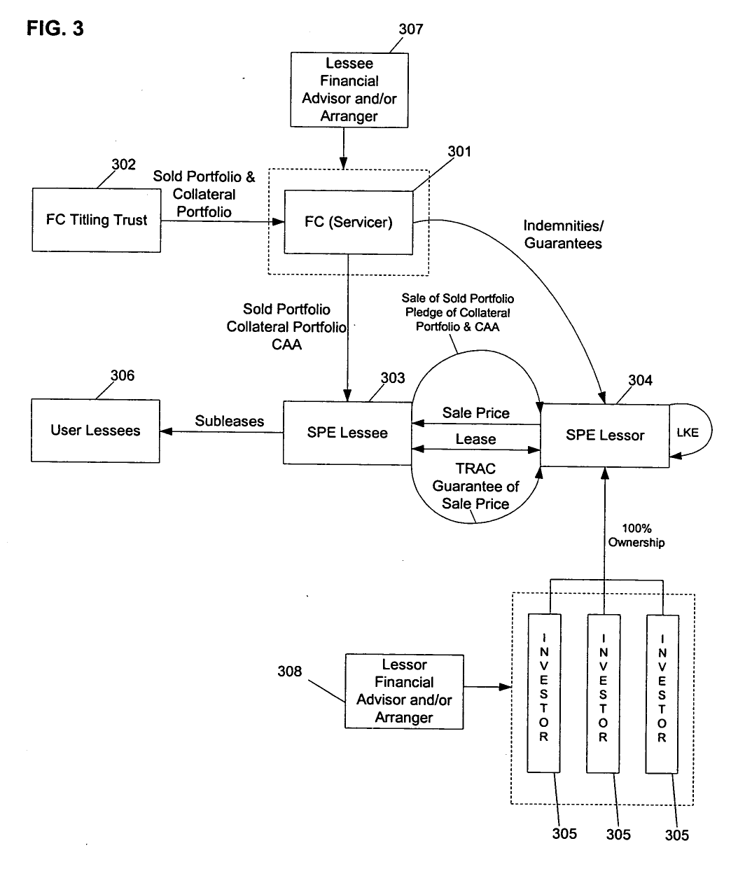

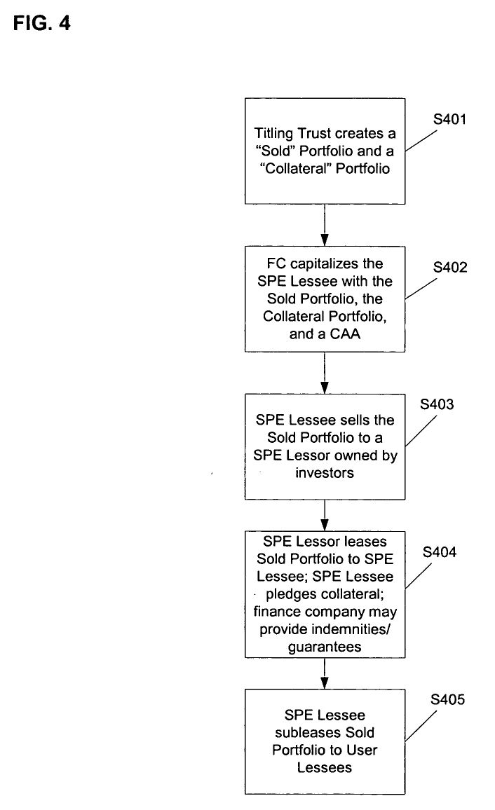

The manner in which the asset-backed investment, according to an embodiment of the present invention, increases DTLs and is otherwise attractive to investors, will now be described with reference to FIGS. 3 and 4. FIG. 3 illustrates a structure of an asset-backed investment, according to an embodiment of the invention, and FIG. 4 illustrates a process of providing an asset-backed investment, according to an embodiment of the invention. Although FIG. 4 is illustrated as having a sequence of steps, one skilled in the art will appreciate that such steps may occur in other sequences than that illustrated in the figure.

FIG. 3 includes a finance company (“FC”) 301 in the business of leasing assets. The assets may be automobiles, motorcycles, airplanes, boats, ships, real property, or any other capital asset in which tax depreciation may be claimed. The finance company 301 may be represented by a lessee financial advisor and/or arranger 307 (“lessee FAA”). The lessee FAA 307 may advise the finance company 301, or any of its related entities, on the structure of the ABS, the marketing of the ABS to investors, the preparation of the offering memorandum, known in the art, discussions with accounting personnel, discussions with tax and/or legal counsel, the investor bid process, documentation, and the closing of the transaction. In certain embodiments, the finance company 301 owns a titling trust 302 that retains title to the leased assets to simplify transfers of the assets. The finance company 301 creates and owns a special purpose entity (“SPE”) 303, which also may be a trust or LLC, to which the finance company 301 transfers, among other things, assets from the titling trust 302. The SPE 303 sells a portion of the assets it acquires from the titling trust 302 to another SPE 304. The SPE 304 may be a trust or LLC and is owned by one or more investors 305. One skilled in the art will appreciate, however, that a plurality of SPEs 304 may be present between the SPE 303 and the investors 305. Optionally, the SPE 304 may be wholly absent, and the investors 305 may directly own the assets transferred to them from the SPE 303. In other words, reference numeral 304 in FIG. 3 may represent one or more investors, an entity owned at least in part by one or more investors, or an entity having an ancestor owned at least in part by one or more investors. One or more of the investors 305 may be represented by a lessor financial advisor and/or arranger 308 (“lessor FAA”). The lessor FAA 308 may advise an investor 305, or any of its related entities, on the structure of the investment, the asset appraisal process, the negotiation of the offering memorandum, known in the art, discussions with accounting personnel, discussions with tax and/or legal counsel, the bidding process, and the closing of the transaction. According to an embodiment of the present invention, the investors 305 are certain insurance companies. One skilled in the art will appreciate, however, that the invention is not limited to any particular type of investor 305. The SPE 304 then leases the assets it acquires from the SPE 303 to the SPE 303. Accordingly, the SPE 304 is referred to as a “lessor,” and the SPE 303 is referred to as a “lessee.” The SPE 303 may then sublease the leased assets to user lessees 306, which may be consumers, for example. In addition, alternative embodiments of the invention can exclude one or more of finance company 301, titling trust 302, SPE 303, SPE 304, user lessees 306, lessee FAA 307, and lessor FAA 308, as would be known to one skilled in the art, as informed by the present disclosure.

The asset-backed investment illustrated in FIG. 3 will now be described in more detail with reference to FIG. 4. At step S401, the finance company 301 instructs its titling trust 302 to create two separate portfolios of assets referred to herein as a “sold portfolio” and a “collateral portfolio.” The sold portfolio and the collateral portfolio may be SUBIs, however, the invention is not so limited. The sold portfolio constitutes the beneficial interest in a portfolio of leases, along with the cash flows and assets associated with the leases, that ultimately are to be sold to the SPE lessor 304. The collateral portfolio constitutes the beneficial interest in a portfolio of leases, along with the cash flows and assets associated with the leases, that ultimately are to be retained by the SPE lessee 303 and pledged to the SPE lessor 304 as security for SPE lessee 303's obligations under its lease with the SPE lessor 304.

At step S402, the finance company 301 capitalizes, or funds, the SPE lessee 303 with the sold portfolio, the collateral portfolio, and a cash accumulation/reserve account (“CAA”), known in the art. At step S403, the SPE lessee 303 sells the sold portfolio to the SPE lessor 304, but retains ownership of the collateral portfolio and the CAA. The SPE lessor 304 accordingly pays the SPE lessee 303 the sales price of the sold portfolio. To fund the purchase of the sold portfolio, the investors 305 make a contribution in aggregate equal to 100% of the sale price of the sold portfolio to the SPE lessor 304.

Because the investors 305 are owners of the sold portfolio assets for tax purposes, they may claim tax depreciation based upon those assets. Depreciation is claimed differently for accounting purposes than for tax purposes. For tax purposes, the investors 305 are able to claim large deductions relative to the value of the assets early in the life of the assets, and small deductions later in the life of the assets. For accounting purposes, however, investors 305 account for the assets as financial assets under direct finance lease accounting. For accounting purposes, the investors 305 recognize a stream of income and the TRAC amount from the rent payments received from SPE 303 under the lease agreement. Because the investors 305 take large tax depreciation deductions up front associated with the assets, they are able to shelter more of their taxable income from tax, deferring payment of such taxes until a later time when taxable income requires larger tax payments than income recognized for GAAP purposes. Accordingly, this deferment of tax payment provides the investors 305 with a deferred tax liability (“DTL”).

At step S404, the SPE lessor 304 leases the sold portfolio assets to the SPE lessee 303 for a predetermined period. The predetermined period may be based upon a useful economic life of the “sold portfolio” of assets. According to an embodiment of the present invention, the predetermined period is generally up to 80% of the useful economic life of the transferred assets. If the assets are leased automobiles, the predetermined period is generally up to 6 to 8 years, assuming an 8 to 10 year economic life for a given automobile. Although the predetermined period may is generally up to 80% of the useful economic life of the transferred assets according to an embodiment of the present invention, the predetermined period may be longer and may be determined independent of a useful economic life of the transferred assets. As part of the lease, the SPE lessee 303 may pledge the collateral portfolio and the CAA as security for its obligations under its lease with the SPE lessor 304. Separately or in addition, the FC 301 may provide indemnities and/or guarantees to the SPE lessor 304 in the event that the SPE lessee 303 is unable to meet its obligations under the lease. At step S405, the SPE lessee 303 may sublease the sold portfolio assets to user lessees 306, which may be consumers.

The lease may include a like-kind exchange (“LKE”) feature. The LKE feature requires that, upon a sale of a leased asset, the proceeds of the sale be reinvested into a new like-kind asset to be leased. In the case of vehicles, pursuant to the provisions of IRS Code Section 1031 or 1033, a like-kind asset may be a vehicle in the same class (e.g. a passenger automobile for another passenger automobile, a light truck for another light truck) as the asset sold. Under the conventional ABS lease structure, which does not incorporate an LKE feature, a sale of an asset, which typically occurs at the end of a lease, results in a taxable event. In other words, the proceeds received from the sale of the asset are taxed. However, by reinvesting the proceeds of the sale into a like-kind asset, the sale is not counted as a taxable event. Further, by continually re-investing the proceeds of asset sales at lease termination, no taxable events occur during the lease between the SPE lessor 304 and the SPE lessee 303 as a result of a termination or maturity of an underlying lease with an end user. Accordingly, the duration of the lease between the SPE lessor 304 and the SPE lessee 303 may be extended beyond the length of a typical retail lease to an end user or sublease, in this case, which generally is two to four years. A longer lease duration between the SPE lessor 304 and the SPE lessee 303 means an increase in time that the investors 305 are able to extend their DTLs, thereby enhancing the effects of their DTLs.

The lease also may include a Terminal Rental Adjustment Clause (“TRAC provision”). The TRAC provision may be pursuant to IRS Code Section 7701(h) and allows the investor to retain the tax ownership of the automobiles while minimizing the risk of a change to the projected or estimated residual value of the automobiles. At the inception of the lease, the sold portfolio assets have an estimated residual value, or “TRAC amount”, that indicates the estimated value of the assets at the end of the lease. Because the investors 305 are the owners of the sold portfolio assets (via the SPE lessor 304), the investors rely upon this estimated residual value as an indicator of the value of their investment upon termination of the lease. The TRAC provision requires that a payment be made from the SPE lessee 303 to the SPE lessor 304 if the actual residual value of the sold portfolio assets at the end of the lease is less than the TRAC amount. The payment may be in an amount corresponding to the difference between the TRAC amount and the actual residual value and may be capped at a predetermined percentage of the price that the SPE lessor 304 paid to the SPE lessee 303 at inception for the sold portfolio assets, such as 22-23%, for example.

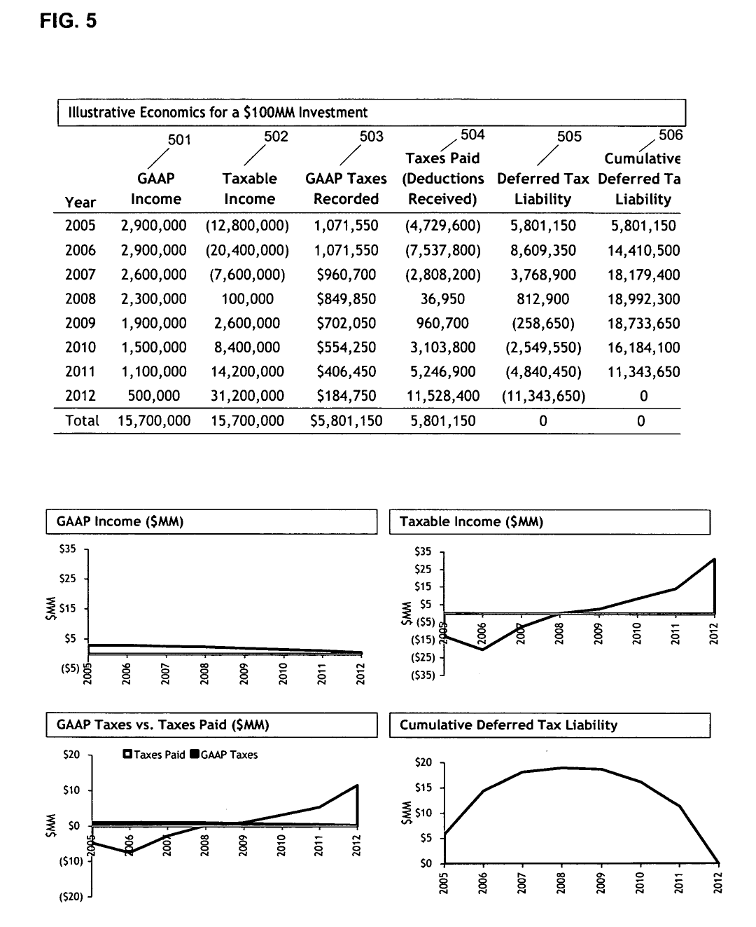

FIGS. 5 and 6A to 6D illustrate the reporting for a $100 million investment, according to an embodiment of the present invention. The example illustrated in FIG. 5 uses automobiles as the sold portfolio assets, incorporates the LKE feature, and has a term of 7.5 years, which is assumed to be 80% of the useful economic life of the automobiles underlying the investment. The GAAP Income column 501 represents income recorded as per the Generally Accepted Accounting Principles, known in the art, and reflects the rental income received by the investor under the terms of the lease agreement (see FIG. 6A). The Taxable Income column 502 represents income recorded for tax purposes, and reflects the front-loaded depreciation deductions allowable for tax purposes (see FIG. 6B). The GAAP Taxes Recorded column 503 equals the GAAP Income column 501 multiplied by a tax rate of 36.95%, assuming a 35% federal tax rate and a 3% state tax rate (see FIG. 6C, dark-filled region). The Taxes Paid (Deductions Received) column 504 equals the Taxable Income column 502 multiplied by a tax rate of 36.95% (see FIG. 6C, light-filled region). The Deferred Tax Liability column 505 equals the GAAP Taxes Recorded column 503 minus the Taxes Paid column 504 and represents the DTL accumulated in each corresponding year. The Cumulative DTL column 506 represents the cumulative DTL for the corresponding year and each previous year (see FIG. 6D).

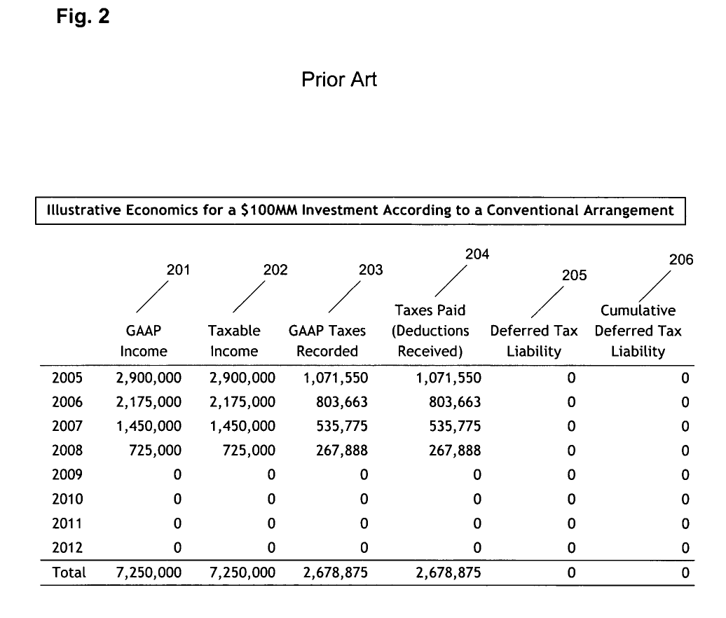

In contrast to the conventional investment illustrated in FIG. 2, the present invention accumulates DTL for the first four years of the investment before the DTL begins declining (column 505). Further, the embodiment of FIG. 5 provides a DTL that lasts until the very last year of the investment (column 506) when the portfolio is either purchased or sold and the SPE Lessor receives taxable income equal to the TRAC amount. Additionally, the length of the transaction according to the embodiment of FIG. 5 lasts 7.5 years due to the LKE feature. In contrast, the conventional investment of FIG. 2 only lasts 4 years, when all of the leases to consumers expire and may not generate any DTLs. Therefore, it can be seen that the present invention provides an improved ABS that is attractive to insurance company investors and other investors.

Implementation and management of the various embodiments of the present invention may be supported by the use of computers and software. For instance, accounting and tax information generated in accordance with the present invention may be generated and/or stored with the use of computers. Contracts and/or other documents needed to implement the invention may be generated and/or stored with the use of computers. Functionality to support billing, keeping track of accounts receivable, and other financial management tasks needed to manage the leases between the SPE Lessor 304 and the SPE Lessee 303, and/or the SPE Lessee 303 and the User Lessees 306, may be provided, at least in part, by computers. Accordingly, one skilled in the art will appreciate that computers may be used to support nearly any aspect of the present invention. However, one skilled in the art also will appreciate that the invention is not limited to any particular arrangement of computers used to support the invention. The term “computer” is intended to include any data processing device, such as a desktop computer, a laptop computer, a mainframe computer, a personal digital assistant, a Blackberry, and/or any other device for processing data, whether implemented with electrical and/or magnetic and/or optical and/or biological components, or otherwise.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

1. A method for implementing an investment backed by one or more assets, the method comprising the steps of:
transferring ownership of at least one asset of the one or more assets to an entity, wherein the one or more assets are assets for which tax depreciation may be claimed, wherein the entity is an investor, an entity owned at least in part by the investor, or an entity having an ancestor owned at least in part by the investor, and wherein the investor is an insurance company;
entering into a lease of the transferred asset(s) from the entity for a predetermined period; and
reinvesting proceeds from a sale of one of the assets transferred to the entity in another asset to be leased without causing taxes to be due on proceeds from the sale.

2. The method of claim 1, wherein the investment is rated.

3. The method of claim I, wherein the investment is Nationally Recognized Statistical Rating Organization (“NRSRO”) rated.

4. The method of claim 1, wherein the lease includes a like-kind exchange provision.

5. (canceled)

6. The method of claim 1, wherein the lease includes a Terminal Rental Adjustment Clause (“TRAC provision”).

7. The method of claim 1, further comprising the step of making a payment if an estimated residual value of the transferred asset(s) exceeds an actual residual value of the transferred asset(s) at the end of the predetermined period.

8. The method of claim 1, wherein the predetermined period is based upon a useful economic life of the transferred asset(s).

9. The method of claim 1, wherein the predetermined period is up to a percentage of a useful economic life of the transferred asset(s).

10. The method of claim 1, wherein an asset of the one or more assets is an automobile, a railcar, a motorcycle, an airplane, a boat, a ship, or real property.

11. The method of claim 1, further comprising the step of retaining at least one of the assets as collateral for the lease.

12. The method of claim 1, further comprising the step of retaining a cash accumulation account as collateral for the lease.

13. A method for implementing an investment backed by one or more assets, the method comprising the steps of:
transferring ownership of at least one asset of the one or more assets to an entity, wherein the one or more assets are assets for which tax depreciation may be claimed, and wherein the entity is an investor, an entity owned at least in part by the investor, or an entity having an ancestor owned at least in part by the investor;
entering into a lease of the transferred asset(s) from the entity for a predetermined period;
reinvesting proceeds from a sale of one of the assets transferred to the entity in another asset to be leased without causing taxes to be due on proceeds from the sale; and
making a payment if an estimated residual value of the transferred asset(s) exceeds an actual residual value of the transferred asset(s) at the end of the predetermined period.

14. An investment instrument backed by an asset, the investment instrument comprising a lease from a first entity to a second entity for an asset sold by the second entity to the first entity, wherein the asset is an asset for which tax depreciation may be claimed, and wherein proceeds from a sale of the asset are reinvested in another asset to be leased.

15. The investment instrument of claim 14, wherein the investment instrument is rated.

16. The investment instrument of claim 14, wherein the investment instrument is Nationally Recognized Statistical Rating Organization (“NRSRO”) rated,

17. The investment instrument of claim 14,
wherein the second entity is a special purpose entity (“SPE”) lessee owned by a finance company and is capitalized with at least a first group of assets, and
wherein the first entity is a SPE lessor that purchases the first group of assets from the SPE lessee with funds from at least one investor, and leases the first group of assets to the SPE lessee for a predetermined period.

18. The investment instrument of claim 17, wherein the at least one investor is an insurance company.

19. The investment instrument of claim 17, wherein ownership of the first group of assets is represented by a specific interest certificate.

20. The investment instrument of claim 17, wherein ownership of the first group of assets is represented by a special unit of beneficial interest.

21. The investment instrument of claim 14, wherein the lease includes a Terminal Rental Adjustment Clause (“TRAC provision”).

22. The investment instrument of claim 17, wherein the SPE lessee makes a payment to the SPE lessor if an estimated residual value of the first group of assets exceeds an actual residual value of the first group of assets.

23. The investment instrument of claim 17, wherein the SPE lessee is further collateralized with a second group of assets that the SPE lessee pledges as security for obligations under the lease.

24. The investment instrument of claim 17, wherein ownership of the second group of assets is represented by a special unit of beneficial interest.

25. The investment instrument of claim 17, wherein ownership of the second group of assets is represented by a specific interest certificate.

26. The investment instrument of claim 17, wherein the SPE lessee is further collateralized with a cash accumulation account that the SPE lessee pledges as security for obligations under the lease.

27. The investment instrument of claim 17, wherein the predetermined period is based upon a useful economic life of the first group of assets.

28. The investment instrument of claim 17, wherein an asset in the first group is an automobile, a railcar, a motorcycle, an airplane, a boat, a ship, or real property.

29. The investment instrument of claim 17, wherein the SPE lessee subleases the first group of assets.

30. An investment instrument backed by an asset, the investment instrument comprising a lease from a first entity to a second entity for an asset sold by the second entity to the first entity,
wherein the asset is an asset for which tax depreciation may be claimed,
wherein proceeds from a sale of the asset are reinvested in another asset to be leased,
wherein the second entity is a special purpose entity (“SPE”) lessee owned by a finance company and is capitalized with at least a first group of assets,
wherein the first entity is a SPE lessor that purchases the first group of assets from the SPE lessee with funds from at least one insurance company investor, and leases the first group of assets to the SPE lessee for a predetermined period,
wherein the predetermined period is based upon a useful economic life of the first group of assets,
wherein the SPE lessee makes a payment to the SPE lessor if an estimated residual value of the first group of assets exceeds an actual residual value of the first group of assets, and
wherein the SPE lessee is further collateralized with a second group of assets that the SPE lessee pledges as security for obligations under the lease.

31. A method for facilitating an investment, the method comprising the step of providing assistance to an involved entity, which is involved with executing the method of claim 13.

32. The method of claim 31, wherein the involved entity is a finance company or an investor.

33. The method of claim 31, wherein the involved entity is an insurance company.

34. A method for facilitating an investment, the method comprising the step of providing assistance to an entity involved with implementing the investment instrument of claim 14.

35. The method of claim 34, wherein the entity involved with implementing the investment instrument is a finance company associated with the second entity or an investor associated with the first entity.

36. A method for facilitating an investment, the method comprising the step of providing assistance to an entity involved with implementing the investment instrument of claim 15.

37. The method of claim 36, wherein the entity involved with implementing the investment instrument is a finance company associated with the second entity or an investor associated with the first entity.

38. A method for facilitating an investment, the method comprising the step of providing assistance to an entity involved with implementing the investment instrument of claim 18.

39. The method of claim 38, wherein the entity involved with implementing the investment instrument is a finance company associated with the second entity or an investor associated with the first entity.

40. A method for facilitating an investment, the method comprising the step of providing assistance to an entity involved with implementing the investment instrument of claim 22.

41. The method of claim 40, wherein the entity involved with implementing the investment instrument is a finance company associated with the second entity or an investor associated with the first entity.
